(19) United States
(12) Patent Application Publication
(10) Pub. No.: US 2007/0056219 A1
(43) Pub. Date: Mar. 15, 2007

(54) Door module

(76) Inventors: Francisco Javier Martinez Morai, Burgos (ES); Rafael Garcia Garcia, San Gil (ES); Joaquin Santaolalla Gil, De la Isla (ES); Cristina Corrales Ortega, Calleja y Zurita (ES)

Correspondence Address: BIRCH STEWART KOLASCH & BIRCH, PO BOX 747, FALLS CHURCH, VA, 22040-0747, US

(21) Appl. No.: 10/548,568

(22) PCT Filed: Sep. 12, 2005
(86) PCT No.: PCT/ES03/00203

§ 371 Date: Sep. 12, 2005

(51) Int. Cl. E05F 15/16

(52) U.S. Cl. 49/502; 49/352; 49/349

(57) ABSTRACT

The invention relates to a door module which is equipped with an outer removable lining comprising optimum operation systems and components. According to the invention, the door module is mounted and removed from the outer face of the door, thereby dispensing with the need for complicated access means from the face which is directed towards the upholstery (1).

The present invention refers to a vehicle door with a modular system on the door panel.

The area of application of this invention is, logically, centred on car doors in general and more specifically in those that use non-structural modular systems in which the mechanical and electrical systems are mounted in the door trim itself, already connected, adjusted and checked, ready for operation once installed on the door, also conserving the integral door structure.

There are currently different types of doors of which only some are adapted for the incorporation of modular sub-assemblies.

Generally, the systems normally used are based on doors with a traditional system of assembly from the inside of the door with respect to the vehicle.

Some of these solutions require modifications to the door structure, partially facilitating assembly and accessibility during installation and adjustment, but on the other hand harming the structural behaviour of the complete door, weakening it, so that the module itself must play a structural role to compensate for this weakening, with the incorporation of structural reinforcing elements.

For this reason, those solutions which, as in the case of this invention, allow modular installation without the need to modify the door structure are considered more advanced.

Among these latter types, there are various mechanical systems to integrate components in the vehicle door in a single modular assembly: door sub-assemblies mounted on a metallic or plastic base (door cassettes) and which can contain the door the mechanisms, window lifters and lock, wiring, loudspeaker, etc.
Structures with an exterior frame that include the exterior door frame, the window pane, the rear view mirror and window lifter and that can also contain an interior sub-structure to reinforce the door.
Others, carrier panels, can include the door mechanisms, window lifter and lock, the wiring, loudspeaker and sealing system, energy absorbing elements, and the panel with all its accessories, such as handles, pull grips, trim, pockets, controls, lights, etc.

Although this last solution is more complete, it requires handling inside the door once the trim has been fitted to affix and adjust the assembly and some of its components.

To do this, openings are made in the panel itself to provide access to the fixing components. It is also necessary to provide the appropriate trim elements to cover these openings once installation is complete.

This last solution, the most complete and advanced, is designed for assembly in doors with traditional structures, also needing, as described, accesses in the door trim and the appropriate elements to cover these accesses.

Examples of this type of elements can be found in applications EP-A-1043182 and WO-0162531 in favour of this applicant.

Despite the advantages of these modular systems compared to any conventional installation system, they offer some operational limitations when being installed in the door.

These arise mainly from the fact that the installation and final adjustment of the components and of the trim itself must all be made from the same side of the door on which the trim is mounted, and once it has been installed.

This fact requires the provision of accesses via the trim, limiting accessibility and visibility for carrying out these assembly operations. Also this form of assembly.

A basic object of the invention is a vehicle door equipped with a removable exterior skin that uses modular systems incorporating the maximum number of functions and components, allowing the installation and removal of the modular system from the external side of the door together with the other components that must be a fitted to the door structure, thus avoiding the need for access openings in the side facing the door's interior trim.

This type of door equipped with an exterior removable skin already exists on the market and offers the feature that they maintain their structure whole compared to traditional door concepts although the exterior skin is assembled in one of the final assembly operations.

This feature is relevant for use with door modules since it facilitates certain assembly operations from the exterior of the door before the assembly of the skin.

The door module in the invention includes an assembly in turn integrated on an interior door trim together with mechanical and electrical devices, the sealing strips system and better acoustical behaviour, the central door structure with structural functions on which the other components are installed and which in turn is fitted to the vehicle itself using the door hinges, and the outer door skin.

Generally, this assembly is fitted to the central door structure as follows: positioning and fixing of the interior trim on the door itself, usually using screws, rivets or clips, with the trim carrying the modular system, sealing systems and heat and sound insulation layers; final fixing on the door, normally using screws, rivets or clips, of the other components such as a window lifters, lock, and door handles, passive safety systems, etc, which must be installed directly on it. In some cases, other sealing elements can also be incorporated, covering the accesses and holes made in the door itself for fitting components from the outermost part of the structure door - installation of the glass on the window lifter mechanism, installation of the external door skin. The outer door skin can be fitted lastly and independently of the rest of the components in the door assembly.

The door panel and the components fixed to the door are assembled from its exterior side.

The fixings in general, both the door trim on the door and the other components fitted on it, are carried out from the external side of the door with the external skin removed, providing total visibility and accessibility to all the fixing points

The outer skin can be removed for later repairs or to replace components or the panel itself.

There is also compatibility with different solutions for modular assembly as well as special adaptability to solutions based on a carrier door trim.

The door trim itself can be made in a single piece, eliminating all types of additional pieces, thus eliminating some sealing problems.

A carrier panel type door module specially designed for this type of door has the following features: no specific access areas are required for screwing the components; these screwing operations are carried out from the exterior side of the door and before the external skin is fixed to the door structure.

This also renders unnecessary the use of removable plastic pieces, for example, medallions, a fact which is typical of the concept of carrier panel type modules designed to be installed from the interior side of the door.

The door trim is fixed to the structure using screws, clips or rivets, with the feature that these screwing or riveting operations of the door panel are made from the exterior part of the door before it is fixed to the door structure.

As described above, acoustic or sealing strips or covers can be used. These elements are positioned between the door module and the internal part of the door to improve the acoustic behaviour and to provide greater sealing against dust and water for the system.

It is also possible to use strips placed inside the door from the exterior before the final installation of the exterior skin.

The door module may carry certain elements which later require a screwing operation in areas that are inaccessible from the inner part of the door, since these connections can also be made from the exterior side of the door before fixing the external skin.

This type of elements are normal in doors, for example, energy absorbing elements, wiring, handles, moving parts of the door mechanism, etc.

The fact that the door trim does not need access areas for joining the elements it carries to the door structure allows them to be made without removable pieces for access.

Therefore, these door trims can be made in a single piece or in several pieces welded together, this being noticeably more economical and providing an important increase in rigidity and sealing. The degree of sound insulation of single piece door trims and those made of pieces welded together is therefore greater than that of trims with removable pieces that must be fixed using clips.

Another advantage of the invention when compared to carrier type modules described in applications EP-A-1043182 and WO-0162531 is that they do not need access areas, which make them totally independent when compared to the previous style of trim.

While in the traditional modular carrier type of panel systems the access areas were needed for screwing the structural sub-systems to the door, these areas are no longer necessary.

This avoids the need to create certain specific design lines to allow the joints to be integrated aesthetically and the limitations that this involves for the design of the panel. This is even more important in cases in which a design it is imposed for the trim that must comply with that of the car manufacturers' designers.

Because the operations of screwing the sub-systems are carried out from the exterior part of the door before the outer skin is fitted, which allows the use of screws or rivets, the need to create covers in the trim to hide the accesses and the screw or rivet heads is avoided.

Also, screwed joints are mechanically stronger than those used in the traditional trims with clips or plastic studs, thus guaranteeing greater dimensional stability, better performance under side shocks and a substantial improvement in noise insulation since they avoid areas with clearances or spaces through which the noise is communicated from the outside of the passenger cabin to its interior. For the same reason, the sealing of the system is much better.

The strips or pads and that are often incorporated between the door module and the door structure to improve the sealing against dust and water in extreme conditions or to improve sound levels, for example in high range vehicles, provide greater performance in the case of this invention since are they are never penetrated by screws or rivets but are fixed on the internal face of the trim or between it and the innermost surface of the door structure or on the outermost face of the door structure.

Likewise, modules made according to this invention, with a removable outer skin, are extraordinarily easy to install and remove in the door since the operations from the exterior part of the door provide a high degree of ergonomics for the workers on the assembly-line by avoiding complicated accesses to certain components.

All of these details and other aspects of the invention are appreciated more specifically in the attached drawings which show the following:

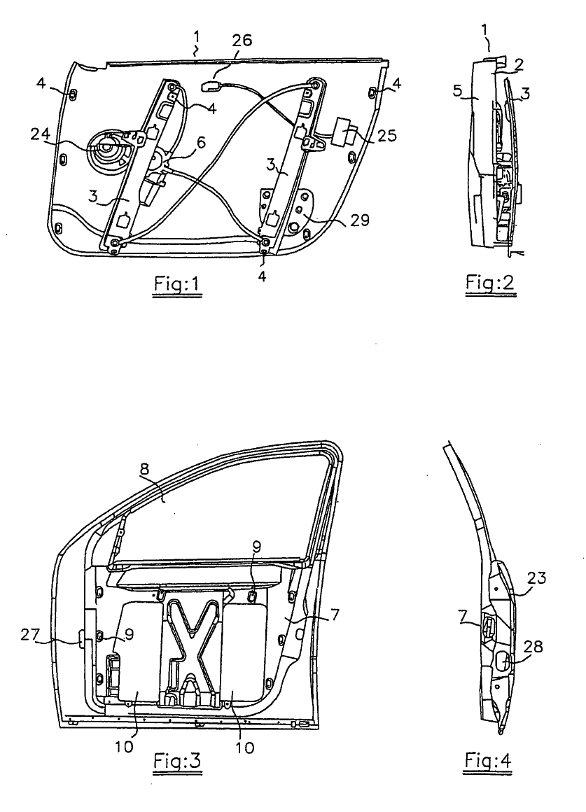

FIG. 1 is a plan of the interior of a trim with a series of elements of components incorporated according to the invention.

FIG. 2 is a side view of the above.

FIG. 3 is a plan of the door structure seen from the trim side.

FIG. 4 is a side view of FIG. 3.

FIG. 5 is a perspective view of the trim in FIG. 1 that fits on to FIG. 6.

FIG. 6 is a perspective view of the door structure in FIG. 3.

FIG. 7 is a perspective view of the door structure with the trim fitted.

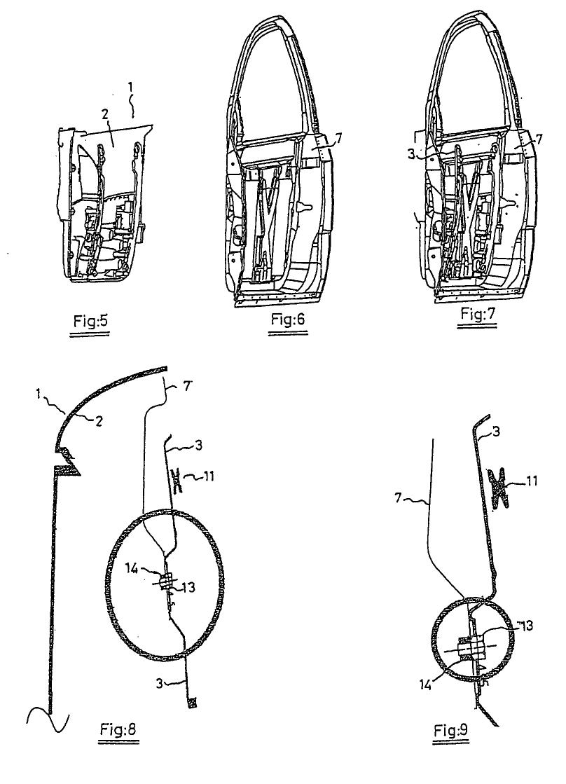

FIG. 8 shows the preferred solution for a screwed joint for the window lifter rails that incorporates the trim to the door structure.

FIG. 9 is an enlarged detail of FIG. 8.

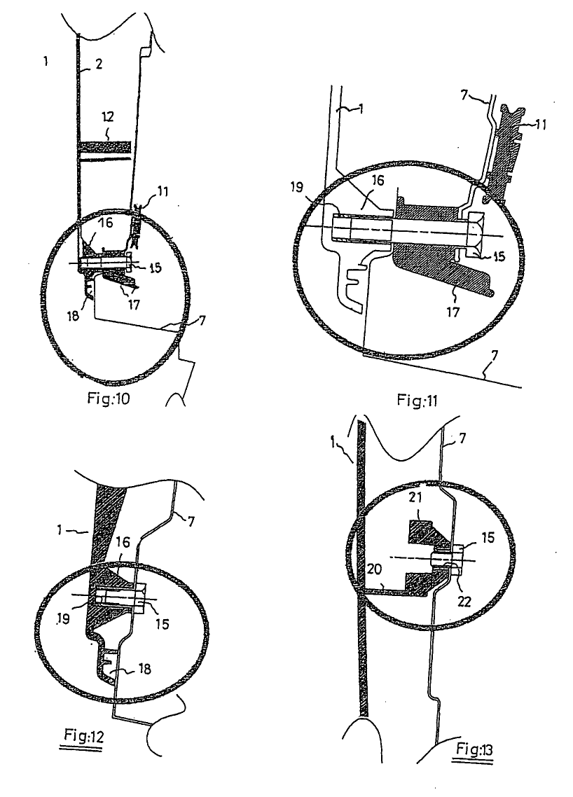

FIG. 10 shows the preferred solution for the screwed joint of the trim to the door.

FIG. 11 is an enlarged detail of the joint in FIG. 10.

FIG. 12 is a one of the variations of the joint shown in FIG. 10.

FIG. 13 is another variant on FIG. 10.

FIGS. 1 and 2 show the trim (1) with its face (2) on the side of the door structure, as a carrier panel, able to carry door mechanisms such as the window lifter rails (3) and the window lifter motor and reducer motor (6) and its fixing points (4), both on the trim itself (1) and on the rails (3), to the door structure as well as other elements located in this housing such as the loudspeaker (24), lock (25) with its mechanism (26) for opening the door and the energy absorbing system (29) and the surrounding seal (18).

This panel (1) shows a surface structure that is completely free of openings or accesses for assembly from its face (5) on the inside of the vehicle, so that all the operations are carried out from the side (2) shown in FIGS. 1 and 2 using screws or rivets.

This face (2) can also incorporate strips to provide sound installation or sealing, fixed on the surface of this face and between it and the door structure, logically freeing the outstanding areas of the various elements.

The door structure in FIGS. 3 and 4 shows its face (7) on the trim side and the opposite face (23) for the fixing of the external skin as well as the opening (8) for holding the window pane with free spaces (10) providing access to the door box as is shown with the location of the door hinges (27) and the grommets (28) for the electrical cables running from the bodywork to the door. The positions (9) show the points for connecting and fixing the trim and the window pane once the trim has been fitted with its different elements as shown in FIG. 5, with the trim (1), FIG. 6 with the door structure and FIG. 7 and this door structure with the trim incorporated.

Once the trim (1) has been offered up and fitted against the door structure (7), with various components filling the spaces (10) provided for the purpose, it is fixed by its external face to the structure using screws and/or rivets.

The rails (3) of the trim (1) can be fixed on the door structure (7) in various ways. For example, the preferred solution in FIGS. 8 and 9 shows this being fixed using a bolt (13) whose head faces the outer part of the door with a bush (14) built into the structure itself (7) into which it is threaded and tightened from the outside.

To make the screwed joint between the trim and the door, a preferred solution in FIGS. 10 and 11 shows a stud (16) on the trim itself in which there is a blind hole that includes a threaded bush (19) to receive a bolt. This bolt (15) is inserted from the door exterior and passes through a shim (17) fitted to the corresponding hole in the door structure (7). This piece (17) has a central hole that aligns with the stud (16) so that the bolt (15) fixes it when inserted from the exterior.

The under part of the trim (1) shows the extension (18) for fitting the seals to the door structure (7). Likewise, a stud (12) on the trim (1) allows it to be supported and seated suitably on the structure (7).

The constructional variation in FIG. 12 shows the bolt (15) passing through the door structure, the stud (16) projecting from the lower part of the trim, including the threaded bush (19) that receives the bolt (15) that is fitted and tightened from the exterior. The trim here also shows the extension (18) to hold the seal between the trim and the door.

In the solution in FIG. 13, the trim shows on its face on the door side the extension (20) for the stud (21) holding the bush (22) to receive the bolt (15) that is inserted from the outside before the outer door skin is fitted.

The trim (1) can be made in a single piece or with various pieces welded together without any removable parts, so its economy is notable and, also, its rigidity and sealing are increased.

With this trim (1) made and with the various components such as window lifter mechanisms and lock, loudspeaker, etc, it is positioned and fixed to the door structure as described, also carrying the appropriate sealing systems and the pads to provide technical and sound insulation.

It is then fixed finally to the door with screws or rivets, with the rest of the components, window lifters, lock, door handles, passive safety systems, etc, all of which must be fitted directly to the door.

The final step is to fit the window pane onto the window lifter system and finally fit the external door panel or skin, independently of the rest of the components in the door assembly.

1. Door module with an interior non-structural door trim (1) that incorporates as a carrier element a series of door components, window lifter mechanisms and others, equipped with openings to provide access for the assembly of the door these elements are fixed to the trim using systems that allow a certain degree of freedom for a suitable adaptation to the layout of the door, a door structure (7) and housing in which are housed and fixed the trim with its components as well as window lifters, lock and other units, the door structure receiving the window pane and being fixed in turn to the door frame and with an outer panel or skin and that seals the assembly, characterized in that the interior door trim (1) can be made as a single piece or with a group of pieces welded together or joined together rigidly and, without any access communicating the vehicle's interior with the door structure (7), in which both the trim itself (1) and the mechanisms (3) for the window lifters or the lock that incorporates this trim are connected and fixed to the door structure from the outside of the door assembly using a suitable means.

2. Door module, as in claim 1, characterized in that it carries all the elements connected, adjusted and checked mechanically and electrically between them, ready to operate once fixed to the door structure.

3. Door module, as in claim 1, characterized in that there are spaces between the door structure and the exterior skin of the door for the sealing systems as well as layers of heat and sound insulation that are independent of the means of connection located between the trim and the door structure.

4. Door module, as in claim 1, characterized in that there are various absorbent or insulating layers between the door structure and the outer skin of the door to improve the technical and acoustic behaviour of the door.

5. Door module, as in claim 1, characterized in that the trim (1) and the window lifter mechanisms (3) are fixed to the door structure (7) using rivets.

6. Door module, as in claim 1, characterized in that the trim (1) and the window lifter mechanisms (3) are fixed to the door structure (7) using screws.

7. Door module, as in claim 1, characterized in that the interior trim (1) consists of a single piece.

8. Door module, as in claim 1, characterized in that the interior trim (1) consists of various components fixed together rigidly.

9. Door module, as in claim 1 characterized in that the mechanisms (3) of the window lifter connected to the trim are fixed to the door structure (7) by means of screws (13) that can be handled from the outside of the door and fit into a bush (14) associated with this door structure.

10. Door module, as in claim 1 characterized in that the inner face (2) of the trim (1) includes a lower extension (16) facing the door structure (7) containing a drilling to receive a threaded bush (19) and aligned with the hole in a piece (17) fitting in turn into a hole in the door structure (7), with a bolt (15) passing through these two pieces (16, 17) whose head can be turned from the exterior of the assembly in which a lower extension (18) to the trim is supported on the door structure (7) receiving seals, also with a support stud (12) on the trim at half height facing the door structure (7).

11. Module, as in claim 1, characterized in that the lower extension (16) of the inner face (2) of the trim abuts to and aligns with the hole in the door structure (7) directly to receive the bolt (15).

12. Module, as in claim 1, characterized in that an arm (20) projects from the inner face (2) of the trim towards the door structure (7) at the end of which there is a trunco-conical extension (21) the front part of which has a hole to receive a bush (22) and which is next to and facing a hole in the door structure (7) in which there is a bolt (15).

13. Door module, as in claim 6 characterized in that the mechanisms (3) of the window lifter connected to the trim are fixed to the door structure (7) by means of screws (13) that can be handled from the outside of the door and fit into a bush (14) associated with this door structure.

14. Door module, as in claim 6 characterized in that the inner face (2) of the trim (1) includes a lower extension (16) facing the door structure (7) containing a drilling to receive a threaded bush (19) and aligned with the hole in a piece (17) fitting in turn into a hole in the door structure (7), with a bolt (15) passing through these two pieces (16, 17) whose head can be turned from the exterior of the assembly in which a lower extension (18) to the trim is supported on the door structure (7) receiving seals, also with a support stud (12) on the trim at half height facing the door structure (7).

15. Module, as in claim 6, characterized in that the lower extension (16) of the inner face (2) of the trim abuts to and aligns with the hole in the door structure (7) directly to receive the bolt (15).

16. Module, as in claim 10, characterized in that the lower extension (16) of the inner face (2) of the trim abuts to and aligns with the hole in the door structure (7) directly to receive the bolt (15).

17. Module, as in claim 10, characterized in that an arm (20) projects from the inner face (2) of the trim towards the door structure (7) at the end of which there is a trunco-conical extension (21) the front part of which has a hole to receive a bush (22) and which is next to and facing a hole in the door structure (7) in which there is a bolt (15).
